(19) United States
(12) Patent Application Publication
(10) Pub. No.: US 2019/0152325 A1
(43) Pub. Date: May 23, 2019

(54) Combined steam electrical automobile drive system

(71) Applicant: John Edward Vandigriff, Carrollton, TX (US)

(72) Inventor: John Edward Vandigriff, Carrollton, TX (US)

(21) Appl. No.: 15/732,487

(22) Filed: Nov. 20, 2017

(51) Int. Cl. B60L 11/12; F01K 7/16; F01D 1/32; F01K 15/02; B60L 11/18; F22B 1/28

(52) U.S. Cl. CPC B60L 11/123; F01K 7/16; F01D 1/32; F01K 15/02; F03G 7/10; F22B 1/284; B60Y 2200/91; Y10S 415/916; B60L 11/1809

(57) ABSTRACT

An automobile drive system that basically uses an electrical motor to power the vehicle includes a steam generator that drives a steam turbine that turns a generator to provide electricity to continually charge the battery that provides energy to the electrical drive motor. With this system the battery is continually being charged and does not have to periodically be plugged into a power source to charge the battery. Also, an additional generator/alternator can be driven by the electrical drive motor or steam turbine to provide additional electrical power as needed.

### FIELD OF THE INVENTION

The invention relates to an automobile drive system, and more particularly to an electrical drive system utilizing a steam generator and steam turbine for providing the electrical drive power.

### BACKGROUND OF THE INVENTION

Automobiles are powered by several different drive systems. Most common is the use of gasoline/diesel to power the automotive engine. Some vehicles are powered by electrical power, but have limit mileage before the battery powering the electrical motor has to be charged. There are the hybrid systems that use both a gasoline engine and an electrical motor to power the vehicle,

### SUMMARY OF THE INVENTION

The present invention is to an automobile drive system that basically uses an electrical motor to power the vehicle, but also uses a steam generator to drive a steam turbine that turns a generator to provide electricity to continually charge the battery that provides energy to the electrical drive motor. With this system the battery is continually being charged and does not have to periodically be plugged into a power source to charge the battery. With this system, there is always power to drive the electrical motor. Also, an additional generator/alternator can be driven by the electrical drive motor or steam turbine to provide additional electrical power as needed.

The technical advance represented by the invention as well as the objects thereof will become apparent from the following description of a preferred embodiment of the invention when considered in conjunction with the accompanying drawings, and the novel features set forth in the appended claims.

### BRIEF DESCRIPTION OF THE DRAWINGS

FIG. 1 illustrates a steam/turbine system that drives a generator for providing voltage to charge a battery, the battery is to provide power to an electrical drive motor (not illustrated in FIG. 1) which provides power to a vehicle.

FIG. 2 illustrates a sectional view of a steam driven turbine that has several joined rotating arms, each arm having a plurality of openings to apply pressurized steam to extensions on the inside of the turbine housing to rotate the arms.

FIG. 3 is a cross-sectional view of the turbine showing the rotating arms, the steam outlet of each arm, and the extensions on the housing to which steam is applied to rotate the arms.

FIG. 4 illustrates an example of a steam generation system in combination with a steam turbine to provide electrical power to an electrical motor to drive a vehicle, control circuitry to interact with the electrical drive system to alternately use several batteries to power the system and to supply power to the steam generation unit, and a water supply for providing water to the steam generation unit.

### DESCRIPTION OF A PREFERRED EMBODIMENT

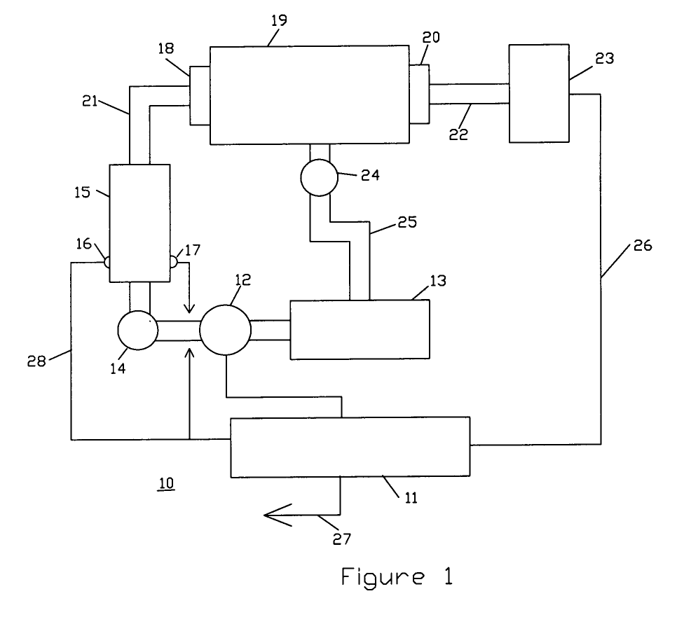

FIG. 1 shows a basic system for producing a voltage to charge a battery that is supplying power to an electrical motor that provides the power to a vehicle. A steam unit 15 generates steam to rotate turbine 19. A water tank 13 supplies water to steam unit 15 by pump 12 which supplies pressurized water to steam unit 15 through a one way valve 14. Valve 14 prevents steam and water introduced into steam unit 15 from flowing back out of the steam unit 15 into pump 12. Power is applied to terminals 16 and 17 of steam unit 15. Terminals 16 and 17 supply a voltage and current to electrical elements (not illustrated)that are internal to steam unit 15 and extend internally partially along the length of steam unit 15. The electrical elements are insulated from the steam unit housing. As pressurized water is inserted into steam unit 15, the water flow around the electrical elements and the voltage applied to terminals 16 and 17 produce a current that flows between the electrical terminals and turns the pressurized water into steam. The steam flows out of steam unit 15 through 21 into turbine 19.

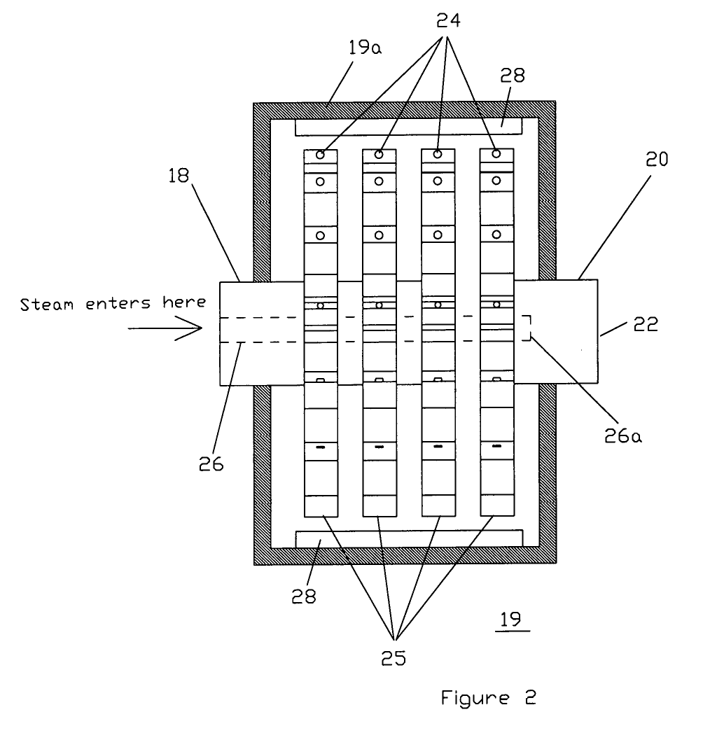

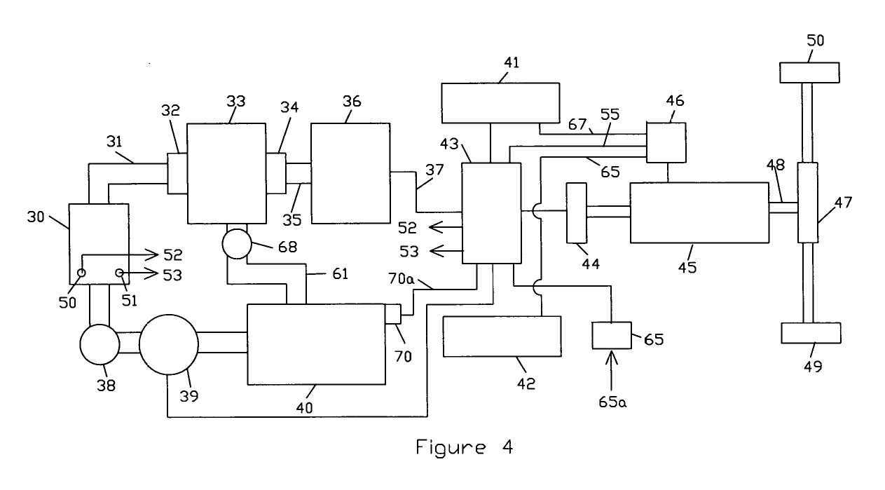

Steam turbine 19 rotates on shaft ends 18 and 20. Steam flows through shaft end 18 from 21, but does not flow completely through the shaft as illustrated in FIG. 2. Shaft 22, rotated by the steam turbine turns generator 23 which supplies power to charge battery 11 via connection 26. Battery 11 supplies power to electrical motor 45 (FIG. 4). When steam is supplied to turbine 19, the steam drives the turbine, but then the steam condense into water. The water is returned to water tank 13 through one way valve 24 and pipe 25.

FIG. 2 is a sectional view of turbine 19. The rotor of the steam turbine includes a plurality of rotating arms 25 that are mounted on the shaft 22 with ends 18 ad 20. Steam flows through the opening 26 that extends partially through the shaft. The end 26a of the opening 26 prevents the steam from exiting out the end 20 of the shaft 22. The steam flows through the arms 25 and exits out the openings 24 and projects the steam against the extension 28 of the housing 19a, rotating the shaft 22.

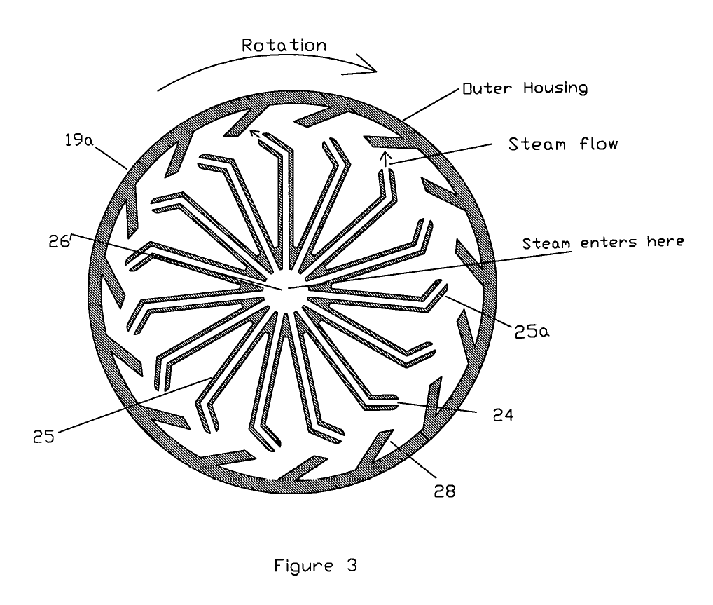

FIG. 3 is a cross section of turbine 19. The outer housing 19a has a series of extensions 28 which are spaced along the inner wall of the outer housing 19a. The rotor 25 has the nozzles 25a spaced around the rotor as illustrated. Each nozzle 25a has an opening 24 from which steam is sprayed against the extensions 28 causing rotor shaft 22 to rotate. Steam enters rotor shaft 22 through the center 26 of shaft end 18 which is hollow and extends through rotor shaft to an end 26a which does not extend to the end 22 of shaft 20 causing the steam to flow up through the nozzles 25 and out openings 24 against the extensions 28. The end of shaft 22 may be connected to a generator to produce a voltage.

FIG. 4 illustrates a system for providing power to drive a vehicle. It could be called a hybrid system using electricity and steam for providing power to an electrical motor. The only fluid used to provide electricity to the electric drive motor is water.

A steam unit 30 generates high pressure steam by moving water from water tank 40 through pump 39 and one way valve 38 into the steam unit 30. The water flows around two electrical elements (not shown) in steam unit 30. A voltage is applied to electrical terminals 51 and 52 which supply a voltage to the internal electrical elements. As water flows through stream unit 30 around the electrical elements the voltage applied to the electrical elements causes a current to flow from one electrical element to the other, turning the water flowing around them into steam.

Electrical drive motor 45 is connected to a gear box 47 by drive shaft 47. Gear box provides the drive to wheels 49 and 50. Electrical drive motor 45 receives power through control switch 46. Control switch is connected to batteries which alternately supply the drive power to electrical motor 45. Control switch is also connected to control unit 43. Control unit 43 is connected to both battery 41 and battery 42. Batteries 41 and 42 received a charging voltage from generator 36 and from generator 44. Generator 44 is turned by electric drive motor 45 and supplies power to control unit 43 and can also be applied to either of the batteries. Control unit 43 monitors the charge on batteries 41 and 42. Control unit 43 detects which battery 41 or 42 needs to be charged and charges that battery while the other battery is supplying power to electric drive motor 45. Control unit 43 sends a signal to control switch 46 to determine which battery is to supply power to electrical drive motor 45. This way the maximum power is supplied to electrical motor 45 from one battery while the other battery is being charged. If neither battery 41, 42 has a low charge, then the steam unit 30 can be shut down by temporarily not supplying power or water to the steam unit. When the control unit senses that a battery has a low charge, then the steam unit is turned on to power turbine 33 which will rotate generator 36 and supply power to the battery getting low in charge.

Control unit 43 supplies the power through connections 52 and 53 to terminals 50 and 51 on steam unit 30. The power supplied to terminal 50 and 51 provided the power to convert the water that pump 39 flows from water tank 40 through one way valve 38 into steam unit 30. The steam produced is directed through pipe 31 into turbine 33. The steam rotates generator 36 supplying power to control unit 43 by connection 37. The steam in turbine will condense into water which is directed through one way valve 68 back into water tank 40 to replenish the water in water tank 40. Water tank 40 includes a monitor 70 which monitors the level of the water in the tank. The monitored information is sent to control unit 43 by connection 70a to alert the control unit 43 that the water is low in water tank 40 and that water needs to be supplied to the water tank 40. Water will not be needed often since the water from the condensed steam is supplied back into the water tank.

Since one battery is being charged while the other is driving the electrical drive motor 45, one of the batteries will generally be at full charge, it is not necessary to plug the system into an electrical out let when the vehicle is not in use. However a power charge connection 65 is connected to the control unit so that if one of the batteries is low in charge, and the vehicle in not in use, the low charge battery can be charged. Power is applied to charge connection by a power source 65a. This way, when the vehicle is in use again, it starts out with both batteries at full charge.

The automobile drive system of the present invention is distinct from the present electrical powered vehicles in that it does not have a limited mileage and does not have to be charged periodically while the vehicle is not in use to charge the battery that powers the electrical motor that moves the vehicle. The drive system continually charges at least one battery to power the electrical motor and with the use of at least two batteries, one can be charged while the other is in use. Also, the generator that provides the power to charge the battery is driven by a steam turbine unit, and the steam is produce by a steam unit on the vehicle.

The description of the invention is basically directed to a drive system for a vehicle. However, the invention can be used in any apparatus that can be turned or rotated by the electrical motor such as boat propeller, and airplane propeller.

What is claimed:

1. An electrical automobile drive system for rotating wheels of an automobile, including an electrical motor powered by at least one battery and including a steam generator and a steam turbine for driving a generator which provides the electrical power source for charging the battery, the steam being a high pressure steam flow generated by passing a continuous flow of high pressure water through the steam generator that converts the high flow of pressurized water to steam by passing the water between and around at least two electrodes to which a voltage is applied and current flows through the water between the at least two electrodes converting the water to steam, a water tank for supplying water to the steam generator, and a drive shaft connected to the electrical motor for turning wheels which move the automobile.

2. The electrical automobile drive system according to claim 1 including a control unit to control the charging of the batteries and for providing power to the steam generator and a pump for supplying the continuous flow of high pressure water to the steam generator from the water tank.

3. The electrical automobile drive system according to claim 2, wherein at least two batteries are used and the control unit controls which battery is in use and which battery is to be charged.

4. The electrical automobile drive system according to claim 1 including two batteries, the water from the water tank supplied to the steam generator, which drives the steam turbine which drives the generator provides power to charge the batteries, a control unit for monitoring the two batteries and charges one while the other is supplying power to the electrical drive motor.

5. The electrical automobile drive system according to claim 4, wherein the control unit measures the power on the two batteries and has a control switch which switches the power between the two batteries, depending upon the measured power remaining on each battery and charges the battery with the lowest power remaining.

6. The electrical automobile drive system according to claim 1 wherein a generator is driven by the electrical motor and supplies power to a control. unit which can be used to provide power to the control unit, the steam generator and the batteries.

7. The electrical automobile drive system according to claim 4, wherein the steam turbine has a return drain so that when the steam in the turbine condenses to water, the water is returned through a one way valve into the water tank, and, the water tank has a water level indicator which supplies information to the control unit to indicate that the water in the tank is low.

8. An electrical automobile drive system for rotating wheels of an automobile including a steam system for turning a generator, an electrical motor driven by at least one battery charged by power from the generator, and a steam unit for rotating a steam turbine that rotates the generator, wherein the steam unit generates steam by inserting pressurized water through a one way valve into a housing, the water flows between and around at least two electrical elements having a voltage applied to them, the current flowing between the electrical elements and through the water produces the steam that rotates the steam turbine.

9. (canceled)

10. The electrical automobile drive system according to claim 8, wherein at least two batteries are used and a control unit controls which battery is in use and which battery is to be charged by power from the generator.

11. (canceled)

12. (canceled)

13. An electrical drive system including an electrical motor which is battery driven, the battery charged by a generator which is turned by a steam turbine, the steam supplied to it is from a steam unit in which the steam is produced by inserting a continuous stream of pressurized water through a one way valve into a housing which has two electrical elements which, when a voltage is applied to the electrical elements, a current flows through the continuous stream of pressurized water in the housing and converts the water instantly to a flow of pressurized steam, the electrical motor powering-wheels which are attached to a drive shaft of the electrical motor and rotated the drive shaft.
